(19) United States
(12) Patent Application Publication
(10) Pub. No.: US 2001/0045778 A1
(43) Pub. Date: Nov. 29, 2001

(54) UNINTERRUPTIBLE POWER SUPPLY

(76) Inventors: TARO ANDO, TOKYO (JP); SHIGEMI KURIYAMA, TOKYO (JP); MANABU YAMAMOTO, TOKYO (JP); MICHIHIRO ARISATO, TOKYO (JP)

Correspondence Address: SUGHRUE MION ZINN MACPEAK & SEAS, 2100 PENNSYLVANIA AVENUE NW, WASHINGTON, DC, 20037

(21) Appl. No.: 09/423,464

(22) PCT Filed: Apr. 27, 1998
(86) PCT No.: PCT/JP98/01931

§ 371 Date: None

(51) Int. Cl. H02J 9/00

(52) U.S. Cl. 307/66

(57) ABSTRACT

In an uninterruptible power system with a battery pack (100) connected replaceably and conductively to a power control device (50) by a connector (104), the battery pack (100) and the power control device (50) are encased in a main box (10) having a battery pack load/unload opening (12). The battery pack load/unload opening (12) is adapted to be opened/closed by a protective cover (14). The opening of the protective cover (14) is detected by a protective cover opening detection switch (22) for detecting the opening of the protective cover (14). When opening of the protective cover (14) is detected by the protective cover opening detection switch (22) while the battery pack (100) is being charged or the backup power is being supplied by the battery pack (100) during a power failure, an internal switching circuit (60) of the power control device (50) is forcibly turned to a substantially open state or an alarm is output by an alarm buzzer (70).

### TECHNICAL FIELD

The present invention relates in general to uninterruptible power systems called UPS. More specifically this invention relates to an uninterruptible power system of such a type in which a battery pack to be replaced upon expiry of the battery life is conductively connected replaceably to a power control device by a connector.

### BACKGROUND ART

An uninterruptible power system (UPS) for continuing to supply power to a load such as a personal computer during a power failure uses in many cases a shielded lead battery repetitively rechargeable as a backup power supply (battery pack). This type of uninterruptible power supply is disclosed, for example, in Japanese Unexamined Patent Publication (Kokai) No. 4-286862.

The available backup time length of the secondary battery such as the shielded lead battery is progressively shortened with the age of the battery due to secular variations, and therefore it is recommended that the battery pack be replaced normally at intervals of two or three years.

In view of this, many uninterruptible power systems are so configured that the battery pack is conductively connected to a power control device by a connector replaceably upon expiry of the battery life.

While the battery pack is being charged, a charge current flows to the battery pack from the power control device. Especially when the battery pack has a small amount of charge, a comparatively large charge current flows to the battery pack. If the battery pack is detached when the charge current is flowing, an electric arc is generated in the connector portion constituting the conductive connector between the power control device and the battery pack, with the probable result that the connector is molten or fused. This causes an early breakdown and the need of replacing the connector.

While the backup power is supplied to the battery pack during a power failure, a backup current flows from the battery pack to the power control device. If the battery pack is detached in this state, the backup power is interrupted and the uninterruptible power supply becomes impossible. Also in this case, an electric arc is generated in the connector portion, with the probable result that the connector is molten or fused. This causes a early breakdown and the need of replacing the connector.

Unlike the battery pack which can be easily replaced, however, it is difficult to replace the connector on the part of the user from the viewpoint of securing the operational reliability of the UPS.

The present invention has been developed in order to obviate the problem described above, and the object thereof is to provide an uninterruptible power system equipped with a protective measure against the detachment of or an attempt to detach the battery pack while the backup power is being supplied by the battery pack during the charging of the battery pack or during a power failure. Further, it is also an object of the present invention to provide an uninterruptible power system capable of avoiding the interruption of the supply of the backup power which otherwise might be caused by the erroneous detachment of battery pack while the backup power is being supplied by the battery pack during the power failure, thereby making it possible to replace the battery pack very safely.

### DISCLOSURE OF THE INVENTION

According to this invention, there is provided an uninterruptible power system comprising a battery pack replaceably and conductively connected to a power control device by a connector, wherein the battery pack and the power control device are encased in a main box having an opening for loading and unloading the battery pack, the battery pack load/unload opening is adapted to be opened and closed by a protective cover, the opening of the protective cover is detected by a detection switch, and when opening of the protective cover is detected by the protective cover opening detection switch while the battery pack is being charged or the backup power is being supplied by the battery pack during a power failure, a internal switching circuit of the power control device is forcibly turned to a substantially open state or an alarm is output.

As a result, if the protective cover is opened while the battery pack is being charged or the backup power is being supplied by the battery pack during a power failure, the fact is detected by the protective cover opening detection switch so that the internal switching circuit of the power control device is forcibly turned to a substantially open state or an alarm is output.

When the internal switching circuit of the power control device is turned to a substantially open state, the charge/discharge current substantially ceases to flow between the battery pack and the power control device. Therefore, even when the battery pack is removed, an electric arc is not generated in the connector portion, thus preventing the connector from being broken at an early time.

The term “substantially” herein indicates that the switching frequency of the internal switching circuit is reduced to zero or to a value almost equal to zero which reduces the current to such an extent that no arc is generated in the connector portion.

Further, the user is prompted by an alarm so as to stop detaching the battery pack at this moment, i.e. while the battery pack is being charged or the backup power is being supplied by the battery pack during a power failure.

According to another aspect of the invention, there is provided an uninterruptible power system comprising a battery pack replaceably and conductively connected to a power control device by a connector, wherein the battery pack and the power control device are encased in a main box having an opening for loading and unloading the battery pack, the battery pack load/unload opening is adapted to be opened/closed by a protective cover, the opening of the protective cover is detected by a detection switch, a charge/discharge current cutoff switch is mounted between the internal switching circuit of the power control device and the connector of the battery pack, and when the opening of the protective cover is detected by the protective cover opening detection switch while the battery pack is being charged or the backup power is being supplied by the battery pack during a power failure, the charge/discharge current cutoff switch is opened or an alarm is output.

As a result, if the protective cover is opened while the battery pack is being charged or the backup power is being supplied by the battery pack during a power failure, the fact is detected by the protective cover opening detection switch, so that the charge/discharge current cutoff switch is opened or an alarm is output.

When the charge/discharge current cutoff switch is opened, the charge or discharge current ceases to flow between the battery pack and the power control device. Even when the battery pack is removed, therefore, no arc is generated in the connector portion, thereby preventing the connector from being broken at an early time.

Also, with this uninterruptible power system, the user can be prompted by an alarm to stop detachment of the battery pack at this moment, i.e. while the battery pack is being charged or the backup power is being supplied by the battery pack during a power failure.

Further, in the uninterruptible power system according to the invention described above, only an alarm can be output when the protective cover is opened and the fact is detected by the protective cover opening detection switch while the backup power is being supplied by the battery pack during a power failure.

In this case, therefore, only an alarm is output when the protective cover is opened while the backup power is being supplied by the battery pack during a power failure and the fact is detected by the protective cover opening detection switch. As a result, the backup power supply mode is maintained and the user can be prompted to withhold from removing the battery pack while the backup power is being supplied.

According to another aspect of the invention, there is provided an uninterruptible power system comprising a battery pack replaceably and conductively connected to a power control device by a connector, wherein the battery pack and the power control device are encased in a main box having an opening for loading and unloading the battery pack, the battery pack load/unload opening is adapted to be opened and closed by a protective cover, the protective cover is locked to a closed position by a protective cover lock unit thereby to selectively prohibit the opening of the protective cover, and the protective cover is locked to the closed position by the protective cover lock unit while the battery pack is being charged or the backup power is being supplied by the battery pack during a power failure.

As a result, while the battery pack is being charged or the backup power is being supplied by the battery pack during a power failure, the protective cover is locked to a closed position by the protective cover lock unit. Thus, while the battery pack is being charged or the backup power is being supplied by the battery pack during a power failure, the opening of the protective cover is prohibited and hence the removal of the battery pack is prohibited.

According to still another aspect of the invention, there is provided an uninterruptible power system comprising a protective cover lock unit for selectively prohibiting the opening of a protective cover by locking the protective cover to a closed position, wherein when the opening of the protective cover is detected by the protective cover opening detection switch while the battery pack is being charged, the internal switching circuit of the power control device is forcibly turned to a substantially open state or a charge/discharge current cutoff switch is opened, and when the opening of the protective cover is detected by the protective cover opening detection switch while the backup power is being supplied by a battery pack during a power failure, the protective cover is locked to the closed position by the protective cover lock unit.

As a result, in the case where the protective cover is opened while the battery pack is being charged, the fact is detected by the protective cover opening detection switch so that the internal switching circuit of the power control device is forcibly turned to a substantially closed state or the charge/discharge current cutoff switch is opened. Thus, the charge/discharge current ceases to flow substantially between the battery pack and the power control device. Even in the case where the battery pack is removed, therefore, no arc is generated in the connector portion and the early breakdown of the connector is prevented.

While the backup power is being supplied by the battery pack during a power failure, the protective cover is locked to a closed position by the protective cover lock unit. Thus, while the backup power is being supplied by the battery pack during a power failure, the opening of the protective cover is prohibited and hence the removal of the battery pack is prohibited, thereby making it possible to continue to supply the backup power.

Further, in the uninterruptible power system according to the invention described above, when the opening of the protective cover is detected by the protective cover opening detection switch while the battery pack is being charged or the backup power is being supplied from the battery pack during a power failure, a warning can be displayed on a display device.

As a result, if the protective cover is opened while the battery pack is being charged or the backup power is being supplied by the battery pack during a power failure, the fact is detected by the protective cover opening detection switch and indicated by a warning on the display device. Thus, the user can be prompted by the warning to withhold from detachment of the battery pack while the battery pack is being charged or the backup power is being supplied by the battery pack during a power failure.

### BRIEF DESCRIPTION OF THE DRAWINGS

FIG. 1 is a perspective view showing the appearance of an uninterruptible power system according to an embodiment of the present invention, FIG. 2 is a plan view showing the layout of a protective cover opening detection switch and a protective cover lock unit of an uninterruptible power system according to the present invention, and FIG. 3 is an electrical circuit diagram of an uninterruptible power system according to an embodiment of the invention.

### BEST MODE FOR CARRYING OUT THE INVENTION

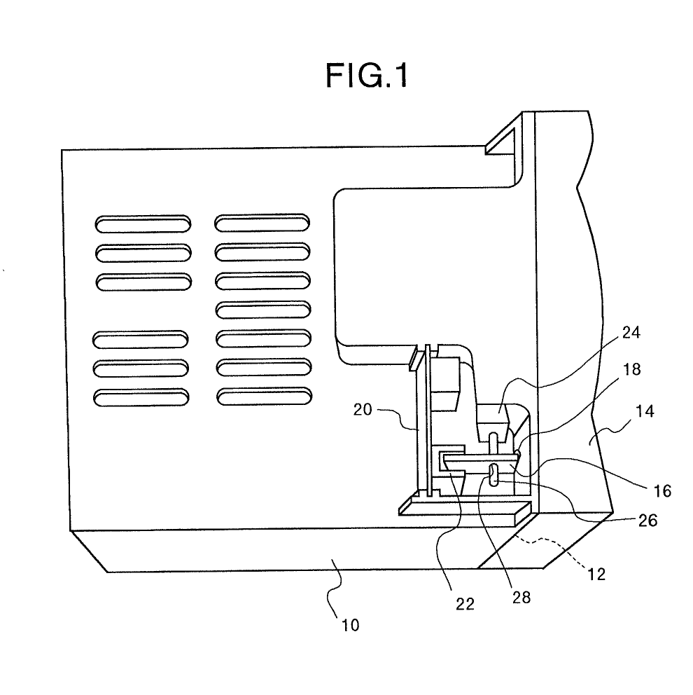

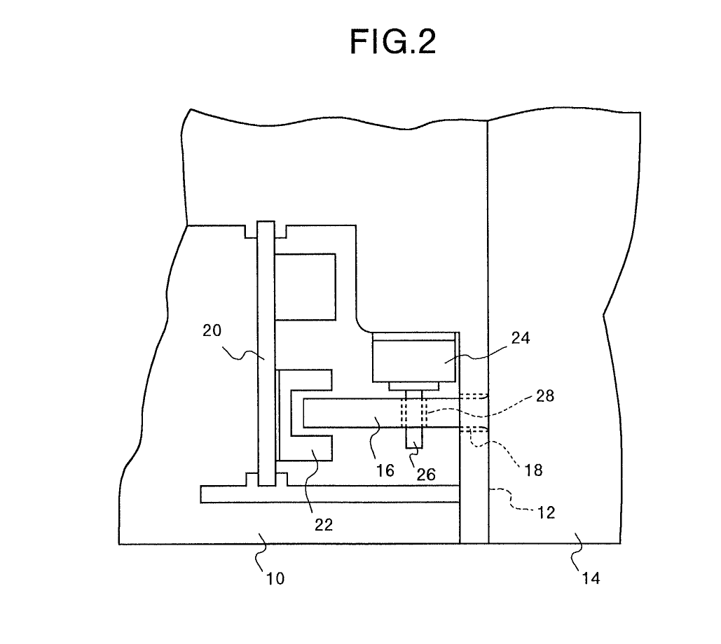

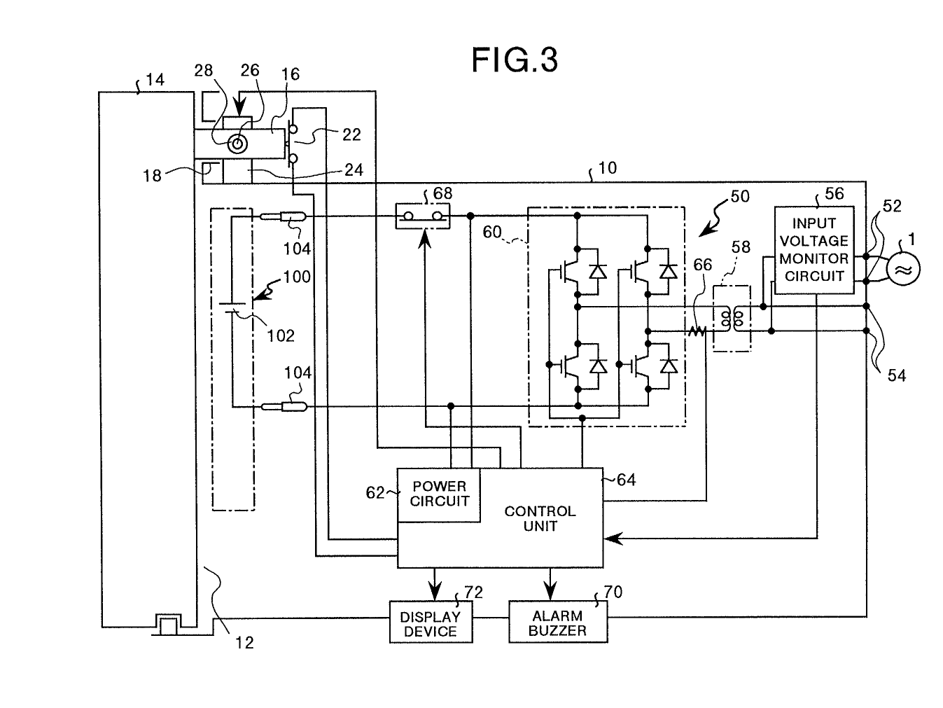

Preferred embodiments of the invention will be explained with reference to FIGS. 1 to 3.

An uninterruptible power system according to the present invention comprises a main box 10 for encasing a battery pack 100 and a power control device 50. This main box 10 has a battery pack load/unload opening 12 in the front surface thereof, and a protective cover 14 removably mounted on the main box 10 for closing the battery pack load/unload opening 12.

The power control device 50 includes an input terminal 52 connected to a commercial AC power supply 1, an output terminal 54 for connecting the electrical equipment requiring an uninterruptible power supply, an input voltage monitor circuit 56 for monitoring the input voltage of the input terminal 52, a transformer 58 with the primary side thereof connected to the input terminal 52 and the output terminal 54, a switching circuit 60 connected to the secondary side of the transformer 58 for AC-DC conversion and DC-AC conversion, and a control circuit 64 having a power circuit 62 for driving the switching circuit 60 at a variable switching frequency.

The control circuit 64 is supplied with an input voltage signal from the input voltage monitor circuit 56 for determining the normal state (uninterrupted state) or an interrupted state. The control circuit 64 is also supplied with a voltage signal of the battery pack 100 from the power circuit 62 and a charge/discharge current signal from the current sensor 66, and in accordance with these signals, sets the switching frequency of the switching circuit 60.

As a result, in the case where the battery voltage drops below a specified value in the normal state, the battery pack 100 is charged, and during a power failure, the backup power is supplied by the battery pack 100.

The battery pack 100 includes a secondary battery 102 such as a shielded lead battery and is removably and conductively connected to the switching circuit 60, i.e. the power control device 50 by the connector 104.

The protective cover 14 is formed with a protruded switch operator 16. The switch operator 16 is arranged through the opening 18 formed in the main box 10 as the protective cover 14 is mounted on the main box 10.

A protective cover opening detection switch 22 operable by a photoelectric switch is mounted on the switch board 20 fixed on the main box 10. The protective cover opening detection switch 22 is opened/closed by the switch operator 16 protruded toward the main box 10 side through the opening 18 thereby detects the opening of the protective cover 14.

The charge/discharge cutoff switch 68 is connected between the internal switching circuit 60 of the power control device 50 and the battery pack connector 104.

The control circuit 64 is connected to an alarm buzzer 70 and a display device 72.

An electromagnetic lock 24 is mounted on the main box 10. For fail-safe operation, the electromagnetic lock 24 prohibits the opening of the protective cover 14 from the main box 10 by fitting a lock bar 26 in a lock hole 28 formed in the switch operator 16 when power is cut off, and permits the opening of the protective cover 14 from the main box 10 by pulling off the lock bar 26 from the lock hole 28 when power is supplied.

The control circuit 64 can determine whether the battery pack 100 is being charged or the backup power is being supplied by the battery pack 100 during a power failure, by the combination of the input voltage signal from the input voltage monitor circuit 56 and the charge/discharge current signal from the current sensor 66. In the case where the battery pack 100 is being charged or the backup power is being supplied by the battery pack 100 during a power failure, the control operations described in (1) to (4) below are performed.

(1) In the case where the opening of the protective cover 14 is detected by the protective cover opening detection switch 22 while the battery pack 100 is being charged, the switching frequency of the internal switching circuit 60 of the power control device 50 is reduced to zero or a value almost equal to zero, so that the internal switching circuit 60 is forcibly turned to a substantially open state. In the case where the opening of the protective cover 14 is detected by the protective cover opening detection switch 22 while the backup power is being supplied by the battery pack 100 during a power failure, on the other hand, the alarm buzzer 70 is turned on thereby to output an alarm.

Also, in the case where the opening of the protective cover 14 is detected by the protective cover opening detection switch 22 while the battery pack 100 is being charged or the backup power is being supplied by the battery pack 100 during a power failure, an alarm is displayed on the display device 72.

As a result, even when the protective cover 14 is opened and hence the battery pack 100 is removed while the battery pack 100 is being charged, no arc is generated in the connector portion and therefore no early breakdown of the connector occurs.

Further, if the protective cover 14 is opened while the backup power is being supplied by the battery pack 100 during a power failure, the user can be prompted by the alarm output from the alarm buzzer 70 or the alarm displayed on the display device 72 to withhold from removing the battery pack 100 while the backup power is being supplied by the battery pack 100 during a power failure.

(2) In the case where the opening of the protective cover 14 is detected by the protective cover opening detection switch 22 while the battery pack 100 is being charged, the charge/discharge current cutoff switch 68 is opened. In the case where the opening of the protective cover 14 is detected by the protective cover opening detection switch 22 while the backup power is being supplied by the battery pack 100 during a power failure, on the other hand, the alarm buzzer 70 is turned on thereby to output an alarm.

Further, if the opening of the protective cover 14 is detected by the protective cover opening detection switch 22 while the battery pack 100 is being charged or the backup power is being supplied by the battery pack 100 during a power failure, an alarm is displayed on the display device 72.

As a result, even when the protective cover 14 is opened and hence the battery pack 100 is removed while the battery pack 100 is being charged, no arc is generated in the connector portion and therefore no early breakdown of the connector occurs.

Further, if the protective cover is opened while the backup power is being supplied by the battery pack 100 during a power failure, the user can be prompted by the alarm output from the alarm buzzer 70 or the warning displayed on the display device 72 to withhold from removing the battery pack 100 while the backup power is being supplied by the battery pack 100 during a power failure.

(3) The opening of the protective cover 14 is prohibited by an electromagnetic lock 24 while the battery pack 100 is being charged or the backup power is being supplied by the battery pack 100 during a power failure.

As a result, while the battery pack 100 is being charged or the backup power is being supplied by the battery pack 100 during a power failure, the removal of the battery pack 100 is prohibited, thereby making it possible to avoid generation of an arc in the connector portion. While the backup power is being supplied by the battery pack 100 during a power failure, the removal of the battery pack 100 is prohibited, and therefore, the interruption of the backup power is avoided for an improved operating reliability of the UPS. (4) While the battery pack 100 is being charged, the switching frequency of the internal switching circuit 60 of the power control device 50 is reduced to zero or a value almost equal to zero so that the internal switching circuit 60 is forcibly turned to a substantially open state or the charge/discharge current cutoff switch 68 is opened. While the backup power is being supplied by the battery pack 100 during a power failure, on the other hand, the opening of the protective cover 14 is prohibited by the electromagnetic lock 24.

If the opening of the protective cover 14 is detected by the protective cover opening detection switch 22 while the battery pack 100 is being charged, an alarm is displayed on the display device 72.

As a result, even when the protective cover 14 is opened and hence the battery pack 100 is removed while the battery pack 100 is being charged, no arc is generated in the connector portion and therefore no early breakdown of the connector occurs.

In addition, while the backup power is being supplied by the battery pack 100 during a power failure, the removal of the battery pack 100 is prohibited so that the generation of an arc in the connector portion is prohibited beforehand. Further, detachment of the battery pack 100 is prohibited so that the interruption of the backup power is avoided for an improved reliability of the UPS operation.

### INDUSTRIAL APPLICABILITY

As described above, an uninterruptible power system according to the invention has the battery pack thereof replacable and is suitable for use with the personal computer or the like.

1. An uninterruptible power system with a battery pack replaceably and conductively connected to a power control device by a connector,
wherein said battery pack and said power control device are encased in a main box having an opening for loading/unloading said battery pack, said battery pack load/unload opening is adapted to be opened/closed by a protective cover, opening of said protective cover is detected by a protective cover opening detection switch, and when opening of said protective cover is detected by said protective cover opening detection switch while said battery pack is being charged or the backup power is being supplied by said battery pack during a power failure, the internal switching circuit of said power control device is forcibly turned to a substantially open state or an alarm is output.

2. The uninterruptible power system according to claim 1, wherein only an alarm is output when opening of said protective cover is detected by said protective cover opening detection switch while the backup power is being supplied by said battery pack during a power failure.

3. The uninterruptible power system according to claim 1, wherein when opening of said protective cover is detected by said protective cover opening detection switch while said battery pack is being charged or the backup power is being supplied by said battery pack during a power failure, a warning is displayed on a display device.

4. The uninterruptible power system according to claim 1, further comprising a protective cover lock unit for selectively prohibiting the opening of said protective cover by locking said protective cover to a closed position, wherein when opening of the protective cover is detected by said protective cover opening detection switch while said battery pack is being charged, the internal switching circuit of said power control device is forcibly turned to a substantially open state, and when opening of the protective cover is detected by said protective cover opening detection switch while the backup power is being supplied by said battery pack during a power failure, said protective cover is locked to a closed position by said protective cover lock unit.

5. An uninterruptible power system with a battery pack replaceably and conductively connected to a power control device by a connector,
wherein said battery pack and said power control device are encased in a main box having an opening for loading/unloading said battery pack, said battery pack load/unload opening is adapted to be opened/closed by a protective cover, opening of said protective cover is detected by a protective cover opening detection switch, a charge/discharge current cutoff switch is interposed between the internal switching circuit of said power control device and said connector for connecting said battery pack, and when the opening of said protective cover is detected by said protective cover opening detection switch while said battery pack is being charged or the backup power is being supplied by said battery pack during a power failure, said charge/discharge current cutoff switch is opened or an alarm is output.

6. The uninterruptible power system according to claim 5, wherein when opening of said protective cover is detected by said protective cover opening detection switch while said battery pack is being charged or the backup power is being supplied by said battery pack during a power failure, a warning is displayed on a display device.

7. The uninterruptible power system according to claim 5, wherein only an alarm is output when opening of said protective cover is detected by said protective cover opening detection switch while the backup power is being supplied by said battery pack during a power failure.

8. The uninterruptible power system according to claim 5, further comprising a protective cover lock unit for selectively prohibiting the opening of said protective cover by locking said protective cover to a closed position, wherein when opening of the protective cover is detected by said protective cover opening detection switch while said battery pack is being charged, said charge/discharge current cutoff switch is opened, and when opening of said protective cover is detected by said protective cover opening detection switch while the backup power is being supplied by said battery pack during a power failure, said protective cover is locked to a closed position by said protective cover lock unit.

9. The uninterruptible power system according to claim 8, wherein when opening of said protective cover is detected by said protective cover opening detection switch while the battery pack is being charged, a warning is displayed on a display device.

10. An uninterruptible power system with a battery pack replaceably and conductively connected to a power control device by a connector,
wherein said battery pack and said power control device are encased in a main box having an opening for loading/unloading said battery pack, said battery pack load/unload opening is adapted to be opened/closed by a protective cover, opening of said protective cover is selectively prohibited by said protective cover lock unit by locking said protective cover to a closed position, and said protective cover is locked to a closed position by said protective lock unit while said battery pack is being charged or the backup power is being supplied by said battery pack during a power failure.
